(19) United States
(12) Patent Application Publication
(10) Pub. No.: US 2013/0051268 A1
(43) Pub. Date: Feb. 28, 2013

(54) Carrier Sense Multiple Access (CSMA) and Collision Detection for Power Line Communications (PLC) Using a Noise Model

(71) Applicants: Marcel Nassar, Austin, TX (US); Il Han Kim, Dallas, TX (US); Tarkesh Pande, Dallas, TX (US); Anand G. Dabak, Plano, TX (US); Ramanuja Vedantham, Allen, TX (US); Kumaran Vijayasankar, Dallas, TX (US)

(72) Inventors: Marcel Nassar, Austin, TX (US); Il Han Kim, Dallas, TX (US); Tarkesh Pande, Dallas, TX (US); Anand G. Dabak, Plano, TX (US); Ramanuja Vedantham, Allen, TX (US); Kumaran Vijayasankar, Dallas, TX (US)

(73) Assignee: TEXAS INSTRUMENTS INCORPORATED, Dallas, TX (US)

(21) Appl. No.: 13/597,010

(22) Filed: Aug. 28, 2012

Related U.S. Application Data
(60) Provisional application No. 61/528,509, filed on Aug. 29, 2011.

(51) Int. Cl. H04B 3/46

(52) U.S. Cl. 370/252

(57) ABSTRACT

Systems and methods for Carrier Sense Multiple Access (CSMA) and collision detection using a noise model are described. In various implementations, these systems and methods may be applicable to Power Line Communications (PLC). For example, a method may include receiving a signal via a communications channel in a PLC network, determining a feature of the signal, comparing the feature of the signal with a corresponding feature of a cyclostationary noise model, and taking a predetermined action based, at least in part, upon the comparison. In some implementations, taking the predetermined action may include determining whether to backoff or to transmit a packet over the communications channel. In other implementations, taking the predetermined action may include determining whether an error is due to a packet collision or due to a low quality of the communications channel.

### CROSS-REFERENCE TO RELATED APPLICATIONS

This application claims the benefit of the filing date of U.S. Provisional Patent Application No. 61/528,509 titled “CSMA and Collision Detection for PLC Systems” and filed on Aug. 29, 2011, the disclosure of which is hereby incorporated by reference herein in its entirety.

### TECHNICAL FIELD

This specification is directed, in general, to network communications, and, more specifically, to systems and methods for Carrier Sense Multiple Access (CSMA) and collision detection in Power Line Communications (PLC) using a noise model.

### BACKGROUND

There are several different types of communication networks available today. For example, power line communications (PLC) include systems for communicating data over the same medium (i.e., a wire or conductor) that is also used to transmit electric power to residences, buildings, and other premises. Once deployed, PLC systems may enable a wide array of applications, including, for example, automatic meter reading and load control (i.e., utility-type applications), automotive uses (e.g., charging electric cars), home automation (e.g., controlling appliances, lights, etc.), and/or computer networking (e.g., Internet access), to name only a few.

For each different type of communications network, different standardizing efforts are commonly undertaken throughout the world. For instance, in the case of PLC communications may be implemented differently depending upon local regulations, characteristics of local power grids, etc. Examples of competing PLC standards include the IEEE 1901, HomePlug AV, and ITU-T G.hn (e.g., G.995) specifications. Another PLC standardization effort includes, for example, the Powerline-Related Intelligent Metering Evolution (PRIME) standard designed for OFDM-based (Orthogonal Frequency-Division Multiplexing) communications.

### SUMMARY

Systems and methods for Carrier Sense Multiple Access (CSMA) and collision detection in Power Line Communications (PLC) using a noise model are described. In an illustrative, non-limiting embodiment, a method may include receiving a signal via a communications channel in a PLC network, determining a feature of the signal, comparing the feature of the signal with a corresponding feature of a cyclostationary noise model, and taking a predetermined action based, at least in part, upon the comparison. In some implementations, the feature may include a spectral shape of the signal. Additionally or alternatively, the feature may include a temporal shape of the signal. Also, the cyclostationary noise model may include two or more temporal regions (e.g., 3 temporal regions), each of the two or more temporal regions having different power and spectral signatures.

In some cases, receiving the signal may include receiving the signal as part of a Carrier Sense Multiple Access (CSMA) operation, and taking the predetermined action may include determining whether to backoff or to transmit a packet over the communications channel. For example, determining whether to backoff or to transmit the packet may include determining to backoff in response to the feature of the signal not matching the corresponding feature of the cyclostationary noise model and/or determining to transmit the packet in response to the feature of the signal matching the corresponding feature of the cyclostationary noise model.

In other cases, receiving the signal may include receiving the signal as part of a diagnostics operation, and taking the predetermined action may include determining whether an error is due to a packet collision or due to a low quality of the communications channel. For example, determining whether the error is due to the packet collision or due to the low quality of the communications channel may include determining that the error is due to the packet collision response to the feature of the signal not matching the corresponding feature of the cyclostationary noise model and/or determining that the error is due to the low quality of the communications channel in response to the feature of the signal matching the corresponding feature of the cyclostationary noise model.

In another illustrative, non-limiting embodiment, a method may include determining a feature of a signal, comparing the feature of the signal with a corresponding feature of a cyclostationary noise model, and taking a predetermined action based, at least in part, upon the comparison.

In some embodiments, one or more communications devices or computer systems may perform one or more of the techniques described herein. In other embodiments, a tangible computer-readable or electronic storage medium may have program instructions stored thereon that, upon execution by one or more communications devices or computer systems, cause the one or more communications devices or computer systems to execute one or more operations disclosed herein. In yet other embodiments, a communications system (e.g., a device or modem) may include at least one processor and a memory coupled to the at least one processor. Examples of a processor include, but are not limited to, a digital signal processor (DSP), an application specific integrated circuit (ASIC), a system-on-chip (SoC) circuit, a field-programmable gate array (FPGA), a microprocessor, or a microcontroller. The memory may be configured to store program instructions executable by the at least one processor to cause the system to execute one or more operations disclosed herein.

### BRIEF DESCRIPTION OF THE DRAWINGS

Having thus described the invention(s) in general terms, reference will now be made to the accompanying drawings, wherein:

FIG. 1 is a block diagram of a power line communication (PLC) environment according to some embodiments.

FIG. 2 is a block diagram of a PLC device or modem according to some embodiments.

FIG. 3 is a block diagram of an integrated circuit according to some embodiments.

FIGS. 4-6 are block diagrams illustrating connections between a PLC transmitter and/or receiver circuitry to three-phase power lines according to some embodiments.

FIG. 7A is a graph illustrating a PLC noise model in the time domain according to some embodiments.

FIG. 7B is a spectrogram illustrating a PLC noise model according to some embodiments.

FIG. 7C is a flowchart of a method for determining PLC noise features according to some embodiments.

FIG. 8 is a flowchart of a method for determining whether a signal detected during a CSMA operation is due to noise or data transmission according to some embodiments.

FIG. 9A is a flowchart of a method for determining whether a packet error is due to noise or collision according to some embodiments.

FIG. 9B shows graphs of Signal-To-Noise Ratio (SNR) metrics for noise and collision-based errors according to some embodiments.

FIG. 10 is a block diagram of a computing system configured to implement certain systems and methods described herein according to some embodiments.

### DETAILED DESCRIPTION

The invention(s) now will be described more fully hereinafter with reference to the accompanying drawings. The invention(s) may, however, be embodied in many different forms and should not be construed as limited to the embodiments set forth herein. Rather, these embodiments are provided so that this disclosure will be thorough and complete, and will fully convey the scope of the invention(s) to a person of ordinary skill in the art. A person of ordinary skill in the art may be able to use the various embodiments of the invention(s).

In various embodiments, the systems and methods described herein may be used to perform Carrier Sense Multiple Access (CSMA) and/or collision detection using a noise model. Generally speaking, these systems and methods may be applicable to a wide variety of communication environments, including, but not limited to, those involving wireless communications (e.g., cellular, Wi-Fi, WiMax, etc.), wired communications (e.g., Ethernet, etc.), Power Line Communications (PLC), or the like. For ease of explanation, several examples discussed below are described specifically in the context of PLC. As a person of ordinary skill in the art will recognize in light of this disclosure, however, certain techniques and principles disclosed herein may also be applicable to other communication environments.

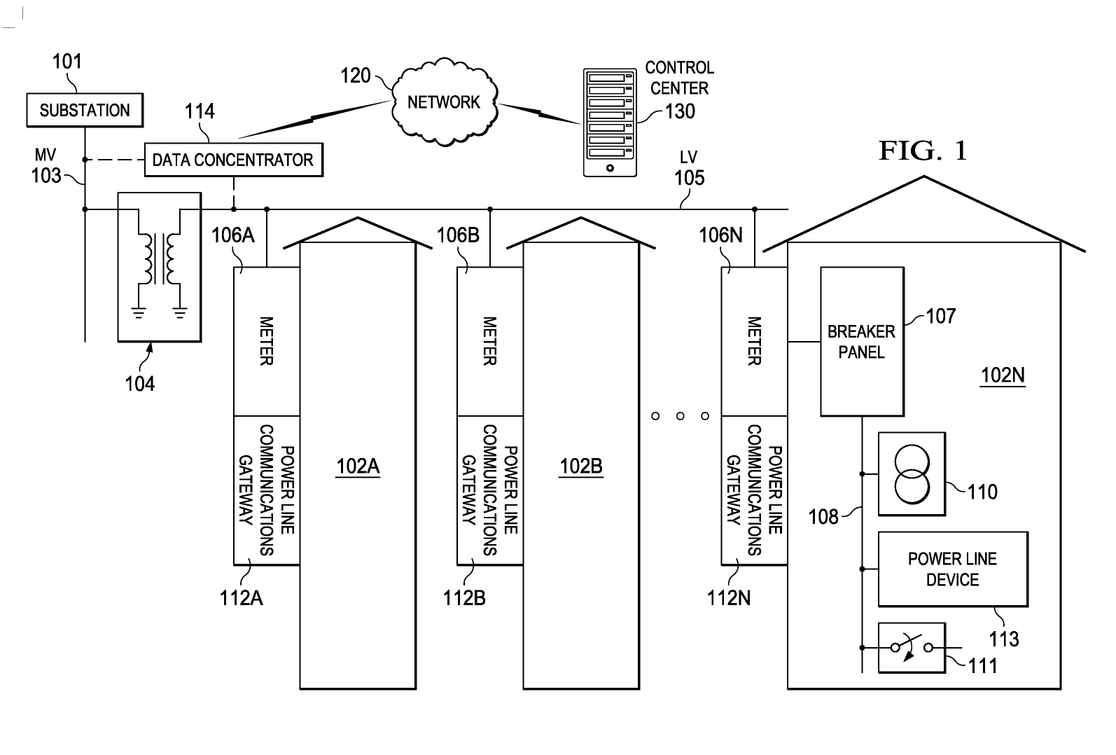

Turning now to FIG. 1, an electric power distribution system is depicted according to some embodiments. Medium voltage (MV) power lines 103 from substation 101 typically carry voltage in the tens of kilovolts range. Transformer 104 steps the MV power down to low voltage (LV) power on LV lines 105, carrying voltage in the range of 100-240 VAC. Transformer 104 is typically designed to operate at very low frequencies in the range of 50-60 Hz. Transformer 104 does not typically allow high frequencies, such as signals greater than 100 KHz, to pass between LV lines 105 and MV lines 103. LV lines 105 feed power to customers via meters 106a-n, which are typically mounted on the outside of residences 102a-n. (Although referred to as “residences,” premises 102a-n may include any type of building, facility or location where electric power is received and/or consumed.) A breaker panel, such as panel 107, provides an interface between meter 106n and electrical wires 108 within residence 102n. Electrical wires 108 deliver power to outlets 110, switches 111 and other electric devices within residence 102n.

The power line topology illustrated in FIG. 1 may be used to deliver high-speed communications to residences 102a-n. In some implementations, power line communications modems or gateways 112a-n may be coupled to LV power lines 105 at meter 106a-n. PLC modems/gateways 112a-n may be used to transmit and receive data signals over MV/LV lines 103/105. Such data signals may be used to support metering and power delivery applications (e.g., smart grid applications), communication systems, high speed Internet, telephony, video conferencing, and video delivery, to name a few. By transporting telecommunications and/or data signals over a power transmission network, there is no need to install new cabling to each subscriber 102a-n. Thus, by using existing electricity distribution systems to carry data signals, significant cost savings are possible.

An illustrative method for transmitting data over power lines may use, for example, a carrier signal having a frequency different from that of the power signal. The carrier signal may be modulated by the data, for example, using an orthogonal frequency division multiplexing (OFDM) scheme or the like.

PLC modems or gateways 112a-n at residences 102a-n use the MV/LV power grid to carry data signals to and from PLC data concentrator 114 without requiring additional wiring. Concentrator 114 may be coupled to either MV line 103 or LV line 105. Modems or gateways 112a-n may support applications such as high-speed broadband Internet links, narrowband control applications, low bandwidth data collection applications, or the like. In a home environment, for example, modems or gateways 112a-n may further enable home and building automation in heat and air conditioning, lighting, and security. Also, PLC modems or gateways 112a-n may enable AC or DC charging of electric vehicles and other appliances. An example of an AC or DC charger is illustrated as PLC device 113. Outside the premises, power line communication networks may provide street lighting control and remote power meter data collection.

One or more data concentrators 114 may be coupled to control center 130 (e.g., a utility company) via network 120. Network 120 may include, for example, an IP-based network, the Internet, a cellular network, a WiFi network, a WiMax network, or the like. As such, control center 130 may be configured to collect power consumption and other types of relevant information from gateway(s) 112 and/or device(s) 113 through concentrator(s) 114. Additionally or alternatively, control center 130 may be configured to implement smart grid policies and other regulatory or commercial rules by communicating such rules to each gateway(s) 112 and/or device(s) 113 through concentrator(s) 114.

In some embodiments, each concentrator 114 may be seen as a base node for a PLC domain, each such domain comprising downstream PLC devices that communicate with control center 130 through a respective concentrator 114. For example, in FIG. 1, device 106a-n, 112a-n, and 113 may all be considered part of the PLC domain that has data concentrator 114 as its base node; although in other scenarios other devices may be used as the base node of a PLC domain. In a typical situation, multiple nodes may be deployed in a given PLC network, and at least a subset of those nodes may be tied to a common clock through a backbone (e.g., Ethernet, digital subscriber loop (DSL), etc.). Further, each PLC domain may be coupled to MV line 103 through its own distinct transformer similar to transformer 104.

Still referring to FIG. 1, meter 106, gateways 112, PLC device 113, and data concentrator 114 may each be coupled to or otherwise include a PLC modem or the like. The PLC modem may include transmitter and/or receiver circuitry to facilitate the device's connection to power lines 103, 105, and/or 108.

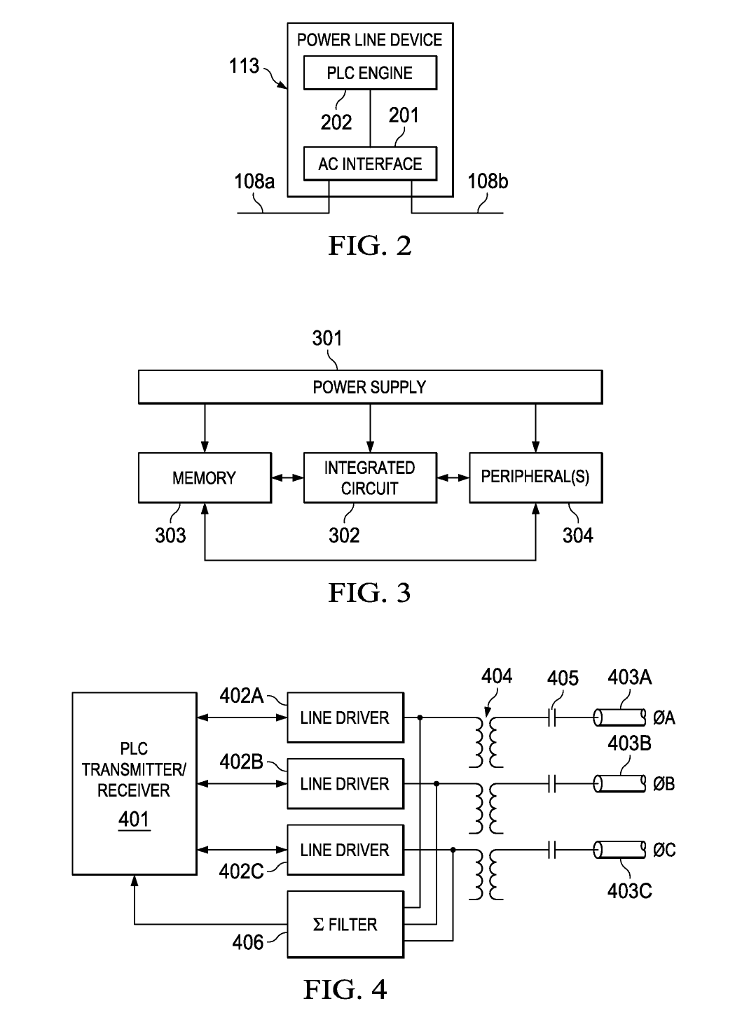

FIG. 2 is a block diagram of PLC device or modem 113 according to some embodiments. As illustrated, AC interface 201 may be coupled to electrical wires 108a and 108b inside of premises 112n in a manner that allows PLC device 113 to switch the connection between wires 108a and 108b off using a switching circuit or the like. In other embodiments, however, AC interface 201 may be connected to a single wire 108 (i.e., without breaking wire 108 into wires 108a and 108b) and without providing such switching capabilities. In operation, AC interface 201 may allow PLC engine 202 to receive and transmit PLC signals over wires 108a-b. As noted above, in some cases, PLC device 113 may be a PLC modem. Additionally or alternatively, PLC device 113 may be a part of a smart grid device (e.g., an AC or DC charger, a meter, etc.), an appliance, or a control module for other electrical elements located inside or outside of premises 112n (e.g., street lighting, etc.).

PLC engine 202 may be configured to transmit and/or receive PLC signals over wires 108a and/or 108b via AC interface 201 using a particular channel or frequency band. In some embodiments, PLC engine 202 may be configured to transmit OFDM signals, although other types of modulation schemes may be used. As such, PLC engine 202 may include or otherwise be configured to communicate with metrology or monitoring circuits (not shown) that are in turn configured to measure power consumption characteristics of certain devices or appliances via wires 108, 108a, and/or 108b. PLC engine 202 may receive such power consumption information, encode it as one or more PLC signals, and transmit it over wires 108, 108a, and/or 108b to higher-level PLC devices (e.g., PLC gateways 112n, data concentrators 114, etc.) for further processing. Conversely, PLC engine 202 may receive instructions and/or other information from such higher-level PLC devices encoded in PLC signals, for example, to allow PLC engine 202 to select a particular frequency band in which to operate.

In various embodiments, PLC device 113 may be implemented at least in part as an integrated circuit. FIG. 3 is a block diagram of such an integrated circuit. In some cases, one or more of meter 106, gateway 112, PLC device 113, or data concentrator 114 may be implemented similarly as shown in FIG. 3. For example, integrated circuit 302 may be a digital signal processor (DSP), an application specific integrated circuit (ASIC), a system-on-chip (SoC) circuit, a field-programmable gate array (FPGA), a microprocessor, a microcontroller, or the like. As such, integrated circuit 302 may implement, at least in part, at least a portion of PLC engine 202 shown in FIG. 2. Integrated circuit 302 is coupled to one or more peripherals 304 and external memory 303. Further, integrated circuit 302 may include a driver for communicating signals to external memory 303 and another driver for communicating signals to peripherals 304. Power supply 301 is also provided which supplies the supply voltages to integrated circuit 302 as well as one or more supply voltages to memory 303 and/or peripherals 304. In some embodiments, more than one instance of integrated circuit 302 may be included (and more than one external memory 303 may be included as well).

Peripherals 304 may include any desired circuitry, depending on the type of PLC device or system. For example, in some embodiments, peripherals 304 may implement, at least in part, at least a portion of a PLC modem (e.g., portions of AC interface 210 shown in FIG. 2). Peripherals 304 may also include additional storage, including RAM storage, solid-state storage, or disk storage. In some cases, peripherals 304 may include user interface devices such as a display screen, including touch display screens or multi-touch display screens, keyboard or other input devices, microphones, speakers, etc. External memory 303 may include any type of memory. For example, external memory 303 may include SRAM, nonvolatile RAM (NVRAM, such as “flash” memory), and/or dynamic RAM (DRAM) such as synchronous DRAM (SDRAM), double data rate (DDR, DDR2, DDR3, etc.) SDRAM, etc. External memory 303 may include one or more memory modules to which the memory devices are mounted, such as single inline memory modules (SIMMs), dual inline memory modules (DIMMs), etc.

In various implementations, PLC device or modem 113 may include transmitter and/or receiver circuits configured to connect to power lines 103, 105, and/or 108. FIG. 4 illustrates a connection between the power line communication transmitter and/or receiver circuitry to the power lines according to some embodiments. PLC transmitter/receiver 401 may function as the transmitter and/or receiver circuit. When PLC transmitter/receiver 401 operates as a transmitter, it may generate pre-coded signals for transmission over the power line network. Each output signal, which may be a digital signal, may be provided to a separate line driver circuit 402A-C. Line drivers 402A-C may comprise, for example, digital-to-analog conversion circuitry, filters, and/or line drivers that couple signals from PLC transmitter/receiver 401 to power lines 403A-C. Transformer 404 and coupling capacitor 405 link each analog circuit/line driver 402 to its respective power line 403A-C. Accordingly, in the embodiment illustrated in FIG. 4, each output signal is independently linked to a separate, dedicated power line. Conversely, when PLC transmitter/receiver 401 operates as a receiver, coded signals may be received on power lines 403A-C, respectively. In an embodiment, each of these signals may be individually received through coupling capacitors 405, transformers 404, and line drivers 402 to PLC transmitter/receiver 401 for detection and receiver processing of each signal separately. Alternatively, the received signals may be routed to summing filter 406, which combines all of the received signals into one signal that is routed to PLC transmitter/receiver 401 for receiver processing.

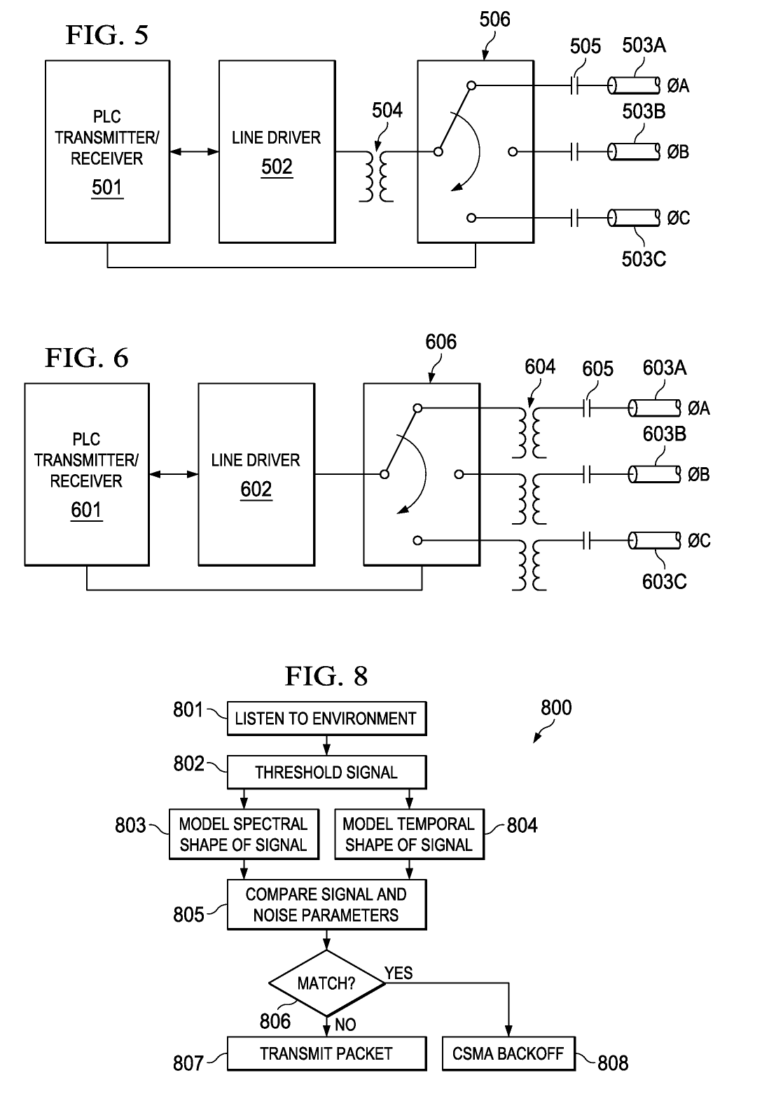

FIG. 5 illustrates an alternative embodiment in which PLC transmitter/receiver 501 is coupled to a single line driver 502, which is in turn coupled to power lines 503A-C by a single transformer 504. All of the output signals are sent through line driver 502 and transformer 504. Switch 506 selects which power line 503A-C receives a particular output signal. Switch 506 may be controlled by PLC transmitter/receiver 501. Alternatively, switch 506 may determine which power line 503A-C should receive a particular signal based upon information, such as a header or other data, in the output signal. Switch 506 links line driver 502 and transformer 504 to the selected power line 503A-C and associated coupling capacitor 505. Switch 506 also may control how received signals are routed to PLC transmitter/receiver 501.

FIG. 6 is similar to FIG. 5 in which PLC transmitter/receiver 1901 is coupled to a single line driver 1902. However, in the embodiment of FIG. 6, power lines 603A-C are each coupled to a separate transformer 604 and coupling capacitor 605. Line driver 602 is coupled to the transformers 604 for each power line 603 via switch 606. Switch 606 selects which transformer 604, coupling capacitor 605, and power line 603A-C receives a particular signal. Switch 606 may be controlled by PLC transmitter/receiver 601, or switch 606 may determine which power line 603A-C should receive a particular signal based upon information, such as a header or other data, in each signal. Switch 606 also may control how received signals are routed to PLC transmitter/receiver 601.

One of the difficulties facing reliable deployment of PLC systems in the field is the aggressive noise experienced by such systems. PLC noise differs significantly from the typical additive white Gaussian noise (AWGN) present in typical communication systems. In addition, it exhibits significant variations between various sites and times of the day. This presents a design challenge for the communication system that needs to adapt to this noisy environment to provide reliable service. Accordingly, in various embodiments, the systems and methods described herein may enable higher data throughput and/or reliability, for example, by providing Carrier Sense Multiple Access (CSMA) and collision detection techniques based, at least in part, upon a suitable modeling of the noise found in the PLC communications channel. These techniques may be implemented, at least in part, through modifications to the Media Access Control (MAC) portion of the communication protocol being employed. Generally speaking, a MAC protocol is a sub-layer of the data link layer specified in the seven-layer Open Systems Interconnection (OSI) model. Particularly, the MAC protocol may provide addressing and channel access control mechanisms that enable terminals or network nodes (e.g., PLC modems, etc.) to communicate over a shared medium (i.e., a power line).

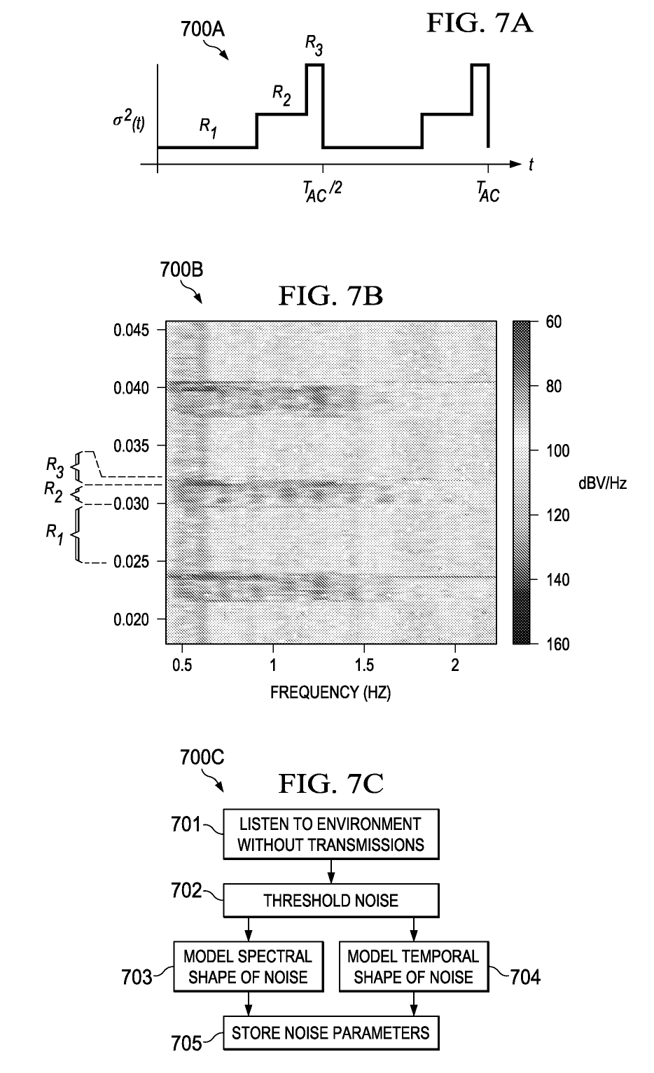

FIG. 7A is a graph illustrating a PLC noise model in the time domain according to some embodiments. Specifically, the inventors hereof have determined that a suitable model for PLC communication channels has cyclostationary properties that repeat every half an AC period (e.g., 60 Hz*2=120 Hz in most of the U.S.). A “cyclostationary signal” is a signal having statistical properties that vary cyclically with time—i.e., as multiple interleaved stationary processes. In particular, the PLC noise in each period may be divided into multiple regions (typically two, three, or four regions), where the noise has a specific power and spectral signature. As shown in graph 700A, three noise regions R₁, R₂, and R₃ are depicted, these regions repeating every T_{AC}/2 period. In each region, the noise spectral shape remains unchanged. For example, R₁ may be a low power background noise region (e.g., of duration equal to ˜0-5 ms), R₂ may be a high power interference region (e.g., of duration equal to ˜5-7 ms), and R₃ may be a broadband impulse (e.g., of duration equal to ˜0.3 ms). Accordingly, the noise may be modeled as the response of a linear periodically time-varying (LPTV) system h[k; τ] to a stationary input s[k], where:

$$h [ k , τ ] = {\sum }_{i = 1}^{M} {h}_{i} [ τ ] {1}_{k ∈ {ℛ}_{i}} , 0 \leq k \leq N - 1$$

and h[k+lN; τ]=h[k; τ] where N is the discrete period corresponding to half the AC-cycle T, lεZ, and 1_{A} is the indicator function (1_{A}=1 if A, 0 otherwise). As a result, the noise n[k] may be given by:

$$n [ k ] = {\sum }_{τ}^{ } h [ k , τ ] s [ τ ] = {\sum }_{i = 1}^{M} {1}_{k ∈ {ℛ}_{i}} {\sum }_{τ}^{ } {h}_{i} [ τ ] s [ τ ]$$

In some cases, the noise model may be parameterized by the number of stationary regions M, the region intervals {Rᵢ: 1≦i≦M}, and Linear Time-Invariant (LTI) filters {hᵢ[k]:1≦i≦M}. The number of stationary regions M and the region boundaries may be inferred by visually inspecting a spectrogram. Furthermore, the stationary assumption during each interval Rᵢ allows for an efficient automated region detection in the time domain that may be implemented on a PLC receiver. In particular, under the assumption that each LTI filter hᵢ[k] has a different power ∥hᵢ∥², each noise sample n[k] may have a power given by:

E{n²[k]}=∥hᵢ∥², kεRᵢ

due to the stationarity assumption. This means that noise samples within each region have equal powers. As a result, a thresholding operation may be used to differentiate regions in the time-domain. Furthermore, in some implementations, a PLC modem may set the thresholds γi to correspond to its adaptive coding and modulation thresholds, thus estimating only the noise parameters that are relevant to the communication performance.

LTI filters {hᵢ[k]: 1≦i≦M} may be spectrum shaping filters, which may be designed using parametric or non-parametric techniques. Generally speaking, parametric models produce more accurate estimates under the correct model assumptions but tend to degrade under model mismatch. On the other hand, non-parametric models generalize well but suffer from an increased noise floor. In narrowband PLC (e.g., between 0 and 500 kHz), the spectral shapes vary significantly between sites and the time of the day, and may include narrowband interferers. In those cases, non-parametric models may be used. Given an estimate of the spectrum Ŝₗ(ω) during Rᵢ, an estimate of the autocorrelation sequence \hat{r}ₗ(τ) during that same interval may be obtained by taking its Inverse Discrete Fourier Transform (IDFT). This sequence may be then used to design the appropriate spectrum shaping filter hᵢ[k]. In addition, frequency domain filtering using a Fast Fourier Transform (FFT) may be applied using the spectral estimate Ŝₗ(ω) followed by an IDFT operation.

An example of the resulting modeling is shown as spectrogram 700B of FIG. 7B. In this illustration, spectral estimates for temporal regions R₁, R₂, and R₃ of FIG. 7A are estimated as Ŝ₁(ω), Ŝ₂(ω), and Ŝ₃(ω), respectively. Applying frequency domain filtering to a unit power AWGN noise, spectrogram 700B shows the fitted model with generated noise samples with spectral and temporal traces.

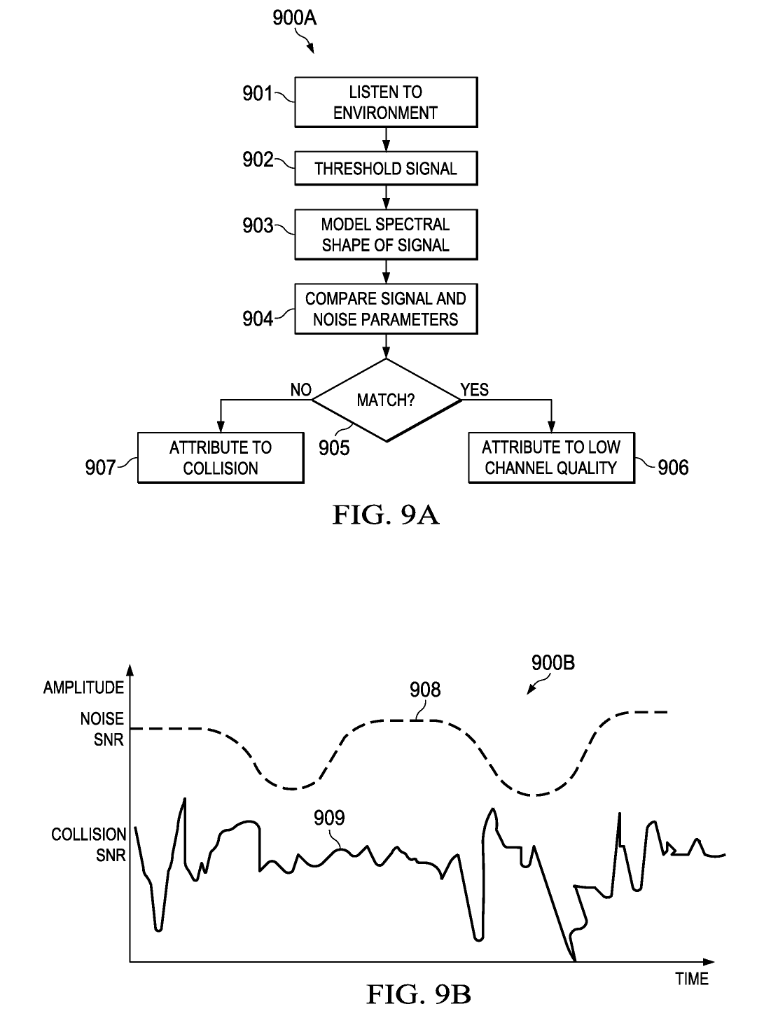

FIG. 7C is a flowchart of a method for determining PLC noise features. In some embodiments, method 700C may be performed, at least in part, by a PLC device such as described in FIG. 1. At block 701, during a non-transmission period (i.e., when PLC devices coupled to the electric grid are not transmitting packets), a transceiver may listen to the environment or communication channel, and collected samples may be used to estimate noise parameters. For example, at block 702, a threshold detection operation may isolate the different regions of the noise over multiple AC periods. Then, at blocks 703 and 704, for each period, method 700C may estimate the spectral shape using parametric or non-parametric techniques, as well as temporal envelope of the noise, respectively. These estimated parameters may be stored at block 705, and may later be used as features to detect the presence of cyclostationary PLC noise, as discussed in FIGS. 8 and 9A below.

Particularly, FIG. 8 is a flowchart of a method for determining whether a signal detected during a CSMA operation is due to noise or data transmission. In some embodiments, the CSMA operation of method 800 may be performed, at least in part, by a PLC device such as described in FIG. 1, for example, after having performed one or more operations of FIG. 7C and in order to determine whether a communications channel is available to carry the PLC device's packet transmission. At block 801, a transceiver may listen to the environment or communication channel. At block 802, a threshold detection operation may isolate the different regions of the received signal, for example, over multiple AC periods. At blocks 703 and 704, for each period, method 800 may estimate the spectral shape and temporal envelope of the signal, respectively. Then, at block 805, method 800 may proceed by using any suitable method to statistically compare previously stored noise features (e.g., obtained via method 700C) with the obtained signal features (e.g., spectral shape and/or temporal envelope).

At block 806, method 800 may determine whether there is a match between the signal and noise parameters. For example, if similarities between the spectral shape of the PLC noise and the spectral shape of the signal meet a first threshold and/or if similarities between the temporal shape of the PLC noise and the temporal shape of the signal meet a second threshold, method 800 may identify a match (i.e., the signal detected on the line is due to PLC noise) and, at block 807, it may determine to transmit a data packet over the communications channel. Conversely, if similarities between the spectral shape of the PLC noise and the spectral shape of the signal do not meet the first threshold and/or if similarities between the temporal shape of the PLC noise and the temporal shape of the signal do not meet the second threshold, method 800 may determine that the signal is sufficiently different from the PLC noise, thus indicating that the communications channel is likely busy with another device's transmission. As such, at block 808, method 800 may implement a CSMA backoff procedure or the like.

FIG. 9A is a flowchart of a method for determining whether a packet error is due to noise or collision according to some embodiments. Again, in some embodiments, the CSMA operation of method 900A may be performed, at least in part, by a PLC device such as described in FIG. 1, for example, after having performed one or more operations of FIG. 7C and/or one or more operations of FIG. 8. Particularly, even after transmissions, such as in block 807, errors may still occur. When there is such an error, it may be desirable to determine whether the error is due to a packet collision or due low communication channel quality (e.g., Signal-to-Noise Ratio or SNR). Since OFDM symbols occupy various band of the 45-450 kHz band used for PLC, while PLC noise mainly occupies the lower bands (below 120 kHz), spectral features may be used to differentiate between the two types of collisions.

Thus, at block 901, a transceiver may listen to the environment or communication channel. At block 902, a threshold detection operation may isolate the different regions of the received signal, for example, over multiple AC periods. At block 903, for each period, method 900A may estimate the spectral shape of the signal. Then, at block 904, method 900A may employ any suitable method to statistically compare previously stored noise features (i.e., the spectral shape of PLC noise) with the obtained signal features (i.e., the spectral shape of the signal). At block 905, method 900A may determine whether there is a match between the signal and noise parameters. If so, then method 900A may attribute the packet error to low channel quality (i.e., the error occurred in the presence of or due to cyclostationary noise). Otherwise, method 900A may attribute the packet error to packet collision (i.e., the error occurred in the absence of significant cyclostationary noise).

FIG. 9B shows graphs of Signal-To-Noise Ratio (SNR) metrics for noise and collision-based errors according to some embodiments. Particularly, curve 908 shows a noise SNR, whereas curve 909 shows a collision SNR. As illustrated, if the packets are long enough or continuous, further detection may be implemented by observing a per OFDM symbol SNR. If the errors are occurring due to PLC noise a cyclic behavior similar to the temporal properties of the noise may be observed. On the other hand, if the errors are due to collisions then the SNR may fluctuate randomly. In some embodiments, the distinction between curves 908 and 909 may be quantified, for example, by counting the number of zero crossings or by using another suitable characterization feature.

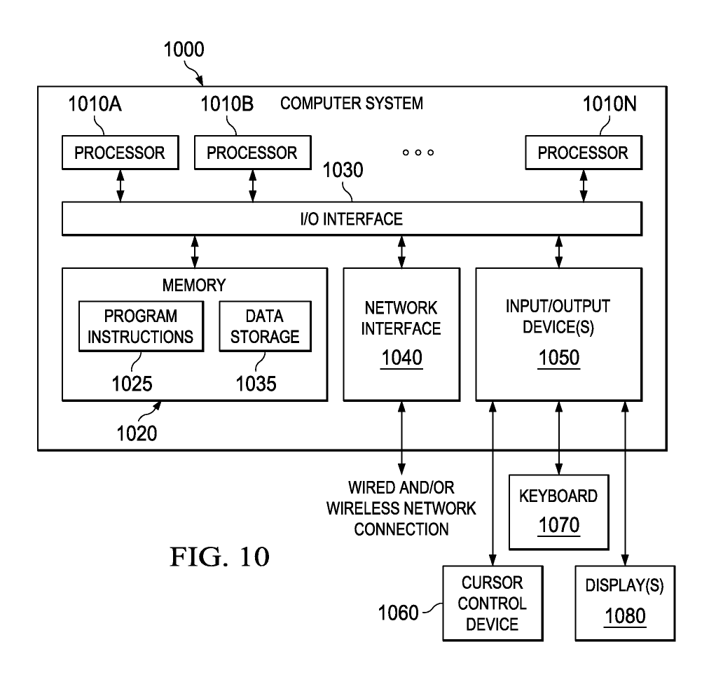

In certain embodiments, one or more of the techniques described above may be executed, at least in part, by one or more communication devices and/or computer systems. One such computer system is illustrated in FIG. 10. In various embodiments, system 1000 may be implemented as a communication device, modem, data concentrator, server, a mainframe computer system, a workstation, a network computer, a desktop computer, a laptop, mobile device, or the like. In different embodiments, these various systems may be configured to communicate with each other in any suitable way, such as, for example, via a local area network or the like.

As illustrated, system 1000 includes one or more processor(s) 1010A-N coupled to a system memory 1020 via an input/output (I/O) interface 1030. Computer system 1000 further includes a network interface 1040 coupled to I/O interface 1030, and one or more input/output devices 1025, such as cursor control device 1060, keyboard 1070, display(s) 1080, and/or mobile device 1090. In various embodiments, computer system 1000 may be a single-processor system including one processor 1010, or a multi-processor system including two or more processors 1010A-N (e.g., two, four, eight, or another suitable number). Processors 1010 may be any processor capable of executing program instructions. For example, in various embodiments, processor(s) 1010A-N may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processors 1010A-N may commonly, but not necessarily, implement the same ISA. Also, in some embodiments, at least one processor 1010A-N may be a graphics processing unit (GPU) or other dedicated graphics-rendering device.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. As illustrated, program instructions and data implementing certain operations such as, for example, those described in the figures above, may be stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include any tangible storage media or memory media such as magnetic or optical media—e.g., disk or CD/DVD-ROM coupled to computer system 1000 via I/O interface 1030. Program instructions and data stored on a tangible computer-accessible medium in non-transitory form may further be transmitted by transmission media or signals such as electrical, electromagnetic, or digital signals, which may be conveyed via a communication medium such as a network and/or a wireless link, such as may be implemented via network interface 1040.

In an embodiment, I/O interface 1030 may be configured to coordinate I/O traffic between processor(s) 1010A-N, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor(s) 1010A-N). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor(s) 1010A-N.

Network interface 1040 may be configured to allow data to be exchanged between computer system 1000 and other devices attached to a network, such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, mobile devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

As shown in FIG. 10, memory 1020 may include program instructions 1025 configured to implement certain embodiments described herein (e.g., implementing one or more operations shown in FIGS. 7C, 8, and/or 9A), and data storage 1035 comprising various data accessible by program instructions 1025. In an embodiment, program instructions 1025 may include software elements of embodiments illustrated in the above figures. For example, program instructions 1025 may be implemented in various embodiments using any desired programming language, scripting language, or combination of programming languages and/or scripting languages (e.g., C, C++, C#, JAVA®, JAVASCRIPT®, PERL®, etc.). Data storage 1035 may include data that may be used in these embodiments (e.g., recorded communications, profiles for different modes of operations, etc.). In other embodiments, other or different software elements and data may be included.

A person of ordinary skill in the art will appreciate that computer system 1000 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be provided and/or other additional operations may be available. Accordingly, systems and methods described herein may be implemented or executed with other computer system configurations.

It will be understood that various operations discussed herein may be executed simultaneously and/or sequentially. It will be further understood that each operation may be performed in any order and may be performed once or repetitiously. In various embodiments, the operations discussed herein may represent sets of software routines, logic functions, and/or data structures that are configured to perform specified operations. Although certain operations may be shown as distinct logical blocks, in some embodiments at least some of these operations may be combined into fewer blocks. Conversely, any given one of the blocks shown herein may be implemented such that its operations may be divided among two or more logical blocks. Moreover, although shown with a particular configuration, in other embodiments these various modules may be rearranged in other suitable ways.

Many of the operations described herein may be implemented in hardware, software, and/or firmware, and/or any combination thereof. When implemented in software, code segments perform the necessary tasks or operations. The program or code segments may be stored in a processor-readable, computer-readable, or machine-readable medium. The processor-readable, computer-readable, or machine-readable medium may include any device or medium that can store or transfer information. Examples of such a processor-readable medium include an electronic circuit, a semiconductor memory device, a flash memory, a ROM, an erasable ROM (EROM), a floppy diskette, a compact disk, an optical disk, a hard disk, a fiber optic medium, etc. Software code segments may be stored in any volatile or non-volatile storage device, such as a hard drive, flash memory, solid state memory, optical disk, CD, DVD, computer program product, or other memory device, that provides tangible computer-readable or machine-readable storage for a processor or a middleware container service. In other embodiments, the memory may be a virtualization of several physical storage devices, wherein the physical storage devices are of the same or different kinds. The code segments may be downloaded or transferred from storage to a processor or container via an internal bus, another computer network, such as the Internet or an intranet, or via other wired or wireless networks.

Many modifications and other embodiments of the invention(s) will come to mind to one skilled in the art to which the invention(s) pertain having the benefit of the teachings presented in the foregoing descriptions, and the associated drawings. Therefore, it is to be understood that the invention(s) are not to be limited to the specific embodiments disclosed. Although specific terms are employed herein, they are used in a generic and descriptive sense only and not for purposes of limitation.

1. A method, comprising:
performing, by a Power Line Communications (PLC) device,
receiving a signal via a communications channel in a PLC network;
determining a feature of the signal;
comparing the feature of the signal with a corresponding feature of a cyclostationary noise model; and
taking a predetermined action based, at least in part, upon the comparison.

2. The method of claim 1, wherein the feature includes a spectral shape of the signal.

3. The method of claim 1, wherein the feature includes a temporal shape of the signal.

4. The method of claim 1, wherein the feature includes a spectral shape and a temporal shape of the signal.

5. The method of claim 1, wherein the cyclostationary noise model includes two or more temporal regions, each of the two or more temporal regions having different power and spectral signatures.

6. The method of claim 5, wherein the two or more temporal regions include 3 regions.

7. The method of claim 1, wherein receiving the signal includes receiving the signal as part of a Carrier Sense Multiple Access (CSMA) operation, and wherein taking the predetermined action includes determining whether to backoff or to transmit a packet over the communications channel.

8. The method of claim 7, wherein determining whether to backoff or to transmit the packet includes at least one of: determining to backoff in response to the feature of the signal not matching the corresponding feature of the cyclostationary noise model, or determining to transmit the packet in response to the feature of the signal matching the corresponding feature of the cyclostationary noise model.

9. The method of claim 1, wherein receiving the signal includes receiving the signal as part of a diagnostics operation, and wherein taking the predetermined action based includes determining whether an error is due to a packet collision or due to a low quality of the communications channel.

10. The method of claim 7, wherein determining whether the error is due to the packet collision or due to the low quality of the communications channel includes at least one of: determining that the error is due to the packet collision response to the feature of the signal not matching the corresponding feature of the cyclostationary noise model, or determining that the error is due to the low quality of the communications channel in response to the feature of the signal matching the corresponding feature of the cyclostationary noise model.

11. A Power Line Communications (PLC) device having a processor and a memory coupled to the processor, the memory configured to store program instructions executable by the processor to cause the PLC device to:
determine a feature of a signal;
compare the feature of the signal with a corresponding feature of a cyclostationary noise model; and
take a predetermined action based, at least in part, upon the comparison.

12. The PLC device of claim 11, wherein receiving the signal includes receiving the signal as part of a Carrier Sense Multiple Access (CSMA) operation, and wherein taking the predetermined action includes determining whether to backoff or to transmit a packet over the communications channel.

13. The PLC device of claim 12, wherein determining whether to backoff or to transmit the packet includes at least one of: determining to backoff in response to the feature of the signal not matching the corresponding feature of the cyclostationary noise model, or determining to transmit the packet in response to the feature of the signal matching the corresponding feature of the cyclostationary noise model.

14. The PLC device of claim 11, wherein receiving the signal includes receiving the signal as part of a diagnostics operation, and wherein taking the predetermined action includes determining whether an error is due to a packet collision or due to a low quality of the communications channel.

15. The PLC device of claim 14, wherein determining whether the error is due to the packet collision or due to the low quality of the communications channel includes at least one of: determining that the error is due to the packet collision response to the feature of the signal not matching the corresponding feature of the cyclostationary noise model, or determining that the error is due to the low quality of the communications channel in response to the feature of the signal matching the corresponding feature of the cyclostationary noise model.

16. A non-transitory electronic storage medium having program instructions stored thereon that, upon execution by a processor within a Power Line Communications (PLC) device, cause the PLC device to:
determine a feature of a signal;
compare the feature of the signal with a corresponding feature of a cyclostationary noise model; and
take a predetermined action based, at least in part, upon the comparison.

17. The non-transitory electronic storage medium of claim 16, wherein receiving the signal includes receiving the signal as part of a Carrier Sense Multiple Access (CSMA) operation, and wherein taking the predetermined action includes determining whether to backoff or to transmit a packet over the communications channel.

18. The non-transitory electronic storage medium of claim 17, wherein determining whether to backoff or to transmit the packet includes at least one of: determining to backoff in response to the feature of the signal not matching the corresponding feature of the cyclostationary noise model, or determining to transmit the packet in response to the feature of the signal matching the corresponding feature of the cyclostationary noise model.

19. The non-transitory electronic storage medium of claim 16, wherein receiving the signal includes receiving the signal as part of an error diagnostics operation, and wherein taking the predetermined action includes determining whether an error is due to a packet collision or due to a low quality of the communications channel.

20. The non-transitory electronic storage medium of claim 19, wherein determining whether the error is due to the packet collision or due to the low quality of the communications channel includes at least one of: determining that the error is due to the packet collision response to the feature of the signal not matching the corresponding feature of the cyclostationary noise model, or determining that the error is due to the low quality of the communications channel in response to the feature of the signal matching the corresponding feature of the cyclostationary noise model.
